(19) United States
(12) Patent Application Publication
(10) Pub. No.: US 2005/0259735 A1
(43) Pub. Date: Nov. 24, 2005

(54) System and method for video error masking using standard prediction

(76) Inventor: Qin-Fan Zhu, Acton, MA (US)

Correspondence Address: MCANDREWS HELD & MALLOY, LTD, 500 WEST MADISON STREET, SUITE 3400, CHICAGO, IL, 60661, US

(21) Appl. No.: 10/970,923

(22) Filed: Oct. 21, 2004

Related U.S. Application Data
(60) Provisional application No. 60/573,103, filed on May 21, 2004.

(51) Int. Cl. H04N 7/12

(52) U.S. Cl. 375/240.16; 375/240.24; 375/240.26; 375/240.27

(57) ABSTRACT

A method and system that conceal errors in video data; the video data comprises frames/fields in a video sequence. A frame/field may be determined to contain an error, and macroblocks within the frame/field may be detected to be corrupt. The method may estimate the mode and the motion vector of each of the corrupt macroblocks to utilize a macroblock from the appropriate frame/field in place of the corrupt macroblock.

### RELATED APPLICATIONS

This patent application makes reference to, claims priority to and claims benefit from U.S. Provisional Patent Application Ser. No. 60/573,103, entitled “System and Method for Video Error Masking Using Standard Prediction,” filed on May 21, 2004, the complete subject matter of which is hereby incorporated herein by reference, in its entirety.

This application is related to the following applications, each of which is incorporated herein by reference in its entirety for all purposes:
U.S. patent application Ser. No. ______ (Attorney Docket No. 15747US02) filed ______, 2004;
U.S. patent application Ser. No. ______ (Attorney Docket No. 15748US02) filed Oct. 13, 2004;
U.S. patent application Ser. No. ______ (Attorney Docket No. 15751US02) filed ______, 2004;
U.S. patent application Ser. No. ______ (Attorney Docket No. 15756US02) filed Oct. 13, 2004;
U.S. patent application Ser. No. ______ (Attorney Docket No. 15757US02) filed ______, 2004;
U.S. patent application Ser. No. ______ (Attorney Docket No. 15759US02) filed ______, 2004;
U.S. patent application Ser. No. ______ (Attorney Docket No. 15760US02) filed ______, 2004;
U.S. patent application Ser. No. ______ (Attorney Docket No. 15762US02) filed Oct. 13, 2004;
U.S. patent application Ser. No. ______ (Attorney Docket No. 15763US02) filed ______, 2004;
U.S. patent application Ser. No. ______ (Attorney Docket No. 15792US01) filed ______, 2004;
U.S. patent application Ser. No. ______ (Attorney Docket No. 15810US02) filed ______, 2004; and
U.S. patent application Ser. No. ______ (Attorney Docket No. 15811US02) filed ______, 2004.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In systems such as video systems where video streams get transmitted from the encoding side to the decoding side, transmission errors such as random bit errors or packet loss, or storage errors such as disk defects, may cause damage to compressed video bit streams presented to a digital video decoder. Because of the nature of modern video compression techniques, such errors can render the decoded video output very objectionable or useless to the human observer.

Currently, video decoders contain the capability of detecting errors in the received bit streams. Some systems may also utilize additional, very complicated, dedicated hardware to minimize the impact of the detected errors. However, using additional hardware is generally undesirable since it increases the complexity of a system.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be seen in a system and method that conceals errors in video data, wherein the video data comprises frames/fields in a video sequence. The method may comprise determining for each frame/field received whether there is an error in the frame/field; detecting corrupted macroblocks within the frame/field, if it is determined an error exists in the frame/field; estimating a mode of prediction and motion vectors associated with each corrupted macroblock; and utilizing a macroblock associated with the estimated mode of prediction in place of the detected corrupt macroblock. Determining whether there is an error in the frame/field may comprise examining information related to the video data. Each frame/field comprises a plurality of macroblocks of data, and a frame/field may have multiple corrupt macroblocks.

In an embodiment of the present invention, the mode of prediction of a macroblock may be spatial. In such an embodiment, a macroblock from the frame/field containing the detected corrupt macroblock may be utilized to replace the corrupt macroblock.

In another embodiment of the present invention, the mode of prediction of a macroblock may be temporal. In such an embodiment, a macroblock from a frame/field decoded prior to the frame/field containing the detected corrupt macroblock may be utilized to replace the corrupt macroblock.

The system comprises at least one processor capable of performing the method that conceals errors in video data, wherein the video data comprises frames/fields in a video sequence.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary video decoder, in accordance with an embodiment of the present invention.

FIG. 2A illustrates a block diagram of a standard digital video decoder.

FIG. 2B illustrates a block diagram of the techniques used in conjunction with the standard digital video decoder of FIG. 2A to conceal errors in video data, in accordance with an embodiment of the present invention.

FIG. 3 illustrates a flow diagram of an exemplary method of concealing errors in video data, in accordance with an embodiment of the present invention.

FIG. 4 illustrates an exemplary computer system, in accordance with an embodiment of the present invention.

### DETAILED DESCRIPTION OF THE INVENTION

Aspects of the present invention generally relate to a method and system for processing an encoded video stream. More specifically, the present invention relates to masking errors in a bit stream using standard prediction methods without increasing the complexity of the system that processes the encoded data. While the following discussion relates to a video system, it should be understood that the present invention may be used in any system where errors may cause corruption of data in a bit stream. Additionally, while the following discusses the method and system in association with one video standard, it should be understood that such techniques as discussed here may be slightly modified to accommodate data encoded using any of the available and future standards.

A video stream may be encoded using an encoding scheme such as the encoder described by U.S. patent application Ser. No. ______ (Attorney Docket No. 15748US02) filed Oct. 13, 2004 entitled “Video Decoder with Deblocker within Decoding Loop.” Accordingly, U.S. patent application Ser. No. ______ (Attorney Docket No. 15748US02) filed Oct. 13, 2004 is hereby incorporated herein by reference in its entirety.

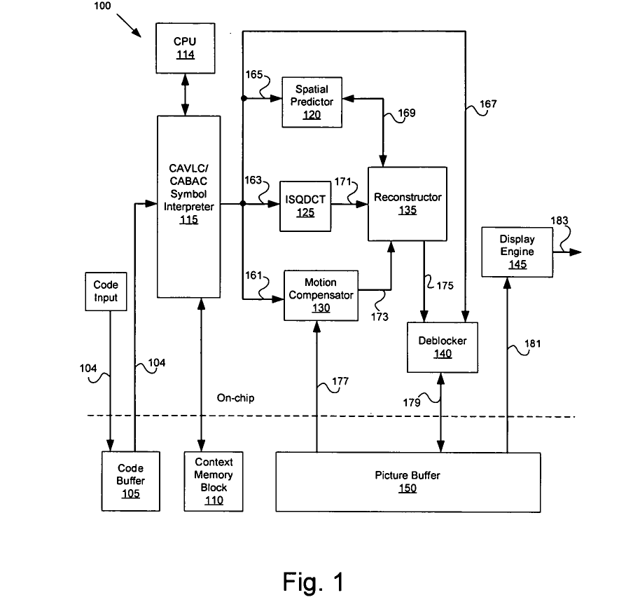

FIG. 1 illustrates a block diagram of an exemplary video decoder 100, in accordance with an embodiment of the present invention. The video decoder 100 may comprise a code buffer 105, a symbol interpreter 115, a context memory block 110, a CPU 114, a spatial predictor 120, an inverse scanner, quantizer, and transformer (ISQDCT) 125, a motion compensator 130, a reconstructor 135, a deblocker 140, a picture buffer 150, and a display engine 145.

The code buffer 105 may comprise suitable circuitry, logic and/or code and may be adapted to receive and buffer the video elementary stream 104 prior to interpreting it by the symbol interpreter 115. The video elementary stream 104 may be encoded in a binary format using CABAC or CAVLC, for example. Depending on the encoding method, the code buffer 105 may be adapted to output different lengths of the elementary video stream as may be required by the symbol interpreter 115. The code buffer 105 may comprise a portion of a memory system such as, for example, a dynamic random access memory (DRAM).

The symbol interpreter 115 may comprise suitable circuitry, logic and/or code and may be adapted to interpret the elementary video stream 104 to obtain quantized frequency coefficients information and additional side information necessary for decoding the elementary video stream 104. The symbol interpreter 115 may also be adapted to interpret either CABAC or CAVLC encoded video stream, for example. In an embodiment of the present invention, the symbol interpreter 115 may comprise a CAVLC decoder and a CABAC decoder. Quantized frequency coefficients 163 may be communicated to the ISQDCT 125, and the side information 161 and 165 may be communicated to the motion compensator 130 and the spatial predictor 120, respectively. Depending on the prediction mode for each macroblock associated with an interpreted set of quantized frequency coefficients 163, the symbol interpreter 115 may provide side information either to a spatial predictor 120, if spatial prediction was used during encoding, or to a motion compensator 130, if temporal prediction was used during encoding. The side information 161 and 165 may comprise prediction mode information and/or motion vector information, for example.

In order to increase processing efficiency, a CPU 114 may be coupled to the symbol interpreter 115 to coordinate the interpreting process for each macroblock within the bitstream 104. In addition, the symbol interpreter 115 may be coupled to a context memory block 110. The context memory block 110 may be adapted to store a plurality of contexts that may be utilized for interpreting the CABAC and/or CAVLC-encoded bitstream. The context memory 110 may be another portion of the same memory system as the code buffer 405, or a portion of another memory system, for example.

After interpreting by the symbol interpreter 115, sets of quantized frequency coefficients 163 may be communicated to the ISQDCT 125. The ISQDCT 125 may comprise suitable circuitry, logic and/or code and may be adapted to generate the prediction error E 171 from a set of quantized frequency coefficients received from the symbol interpreter 115. For example, the ISQDCT 125 may be adapted to transform the quantized frequency coefficients 163 back to spatial domain using an inverse transform. After the prediction error E 171 is generated, it may be communicated to the reconstructor 135.

The spatial predictor 120 and the motion compensator 130 may comprise suitable circuitry, logic and/or code and may be adapted to generate prediction pixels 169 and 173, respectively, utilizing side information received from the symbol interpreter 115. For example, the spatial predictor 120 may generate the prediction pixels P 169 for spatially predicted macroblocks, while the motion compensator 130 may generate prediction pixels P 173 for temporally predicted macroblocks. The prediction pixels P 173 may comprise prediction pixels P₀ and P₁, for example, associated with motion compensation vectors in frames/fields neighboring a current frame/field. The motion compensator 130 may retrieve the prediction pixels P₀ and P₁ from the picture buffer 150 via the connection 177. The picture buffer 150 may store previously decoded frames or fields.

The reconstructor 135 may comprise suitable circuitry, logic and/or code and may be adapted to receive the prediction error E 171 from the ISQDCT 125, as well as the prediction pixels 173 and 169 from either the motion compensator 130 or the spatial predictor 120, respectively. The pixel reconstructor 135 may then reconstruct a macroblock 175 from the prediction error 171 and the side information 169 or 173. The reconstructed macroblock 175 may then be communicated to a deblocker 140, within the decoder 100.

If the spatial predictor 120 is utilized for generating prediction pixels, reconstructed macroblocks may be communicated back from the reconstructor 135 to the spatial predictor 120. In this way, the spatial predictor 120 may utilize pixel information along a left, a corner or a top border with a neighboring macroblock to obtain pixel estimation within a current macroblock.

The deblocker 140 may comprise suitable circuitry, logic and/or code and may be adapted to filter the reconstructed macroblock 175 received from the reconstructor 135 to reduce artifacts in the decoded video stream. The deblocked macroblocks may be communicated via the connection 179 to the picture buffer 150.

The picture buffer 150 may be adapted to store one or more decoded pictures comprising deblocked macroblocks received from the deblocker 140 and to communicate one or more decoded pictures to the display engine 145 and to the motion compensator 130. In addition, the picture buffer 150 may communicate a previously decoded picture back to the deblocker 140 so that the deblocker may deblock a current macroblock within a current picture.

A decoded picture buffered in the picture buffer 150 may be communicated via the connection 181 to a display engine 145. The display engine may then output a decoded video stream 183. The decoded video stream 183 may be communicated to a video display, for example.

The symbol interpreter 115 may generate the plurality of quantized frequency coefficients from the encoded video stream. The video stream 104 received by the symbol interpreter 115 may be encoded utilizing CAVLC and/or CABAC. In this regard, the symbol interpreter 115 may comprise a CAVLC interpreter and a CABAC interpreter, for example, which may be adapted to interpret CAVLC and/or CABAC-encoded symbols, respectively. After symbol interpretation, the symbol interpreter may communicate quantized frequency coefficients 163 to the ISQDCT 125, and side information 165 and 161 to the spatial predictor 120 and the motion compensator 130, respectively.

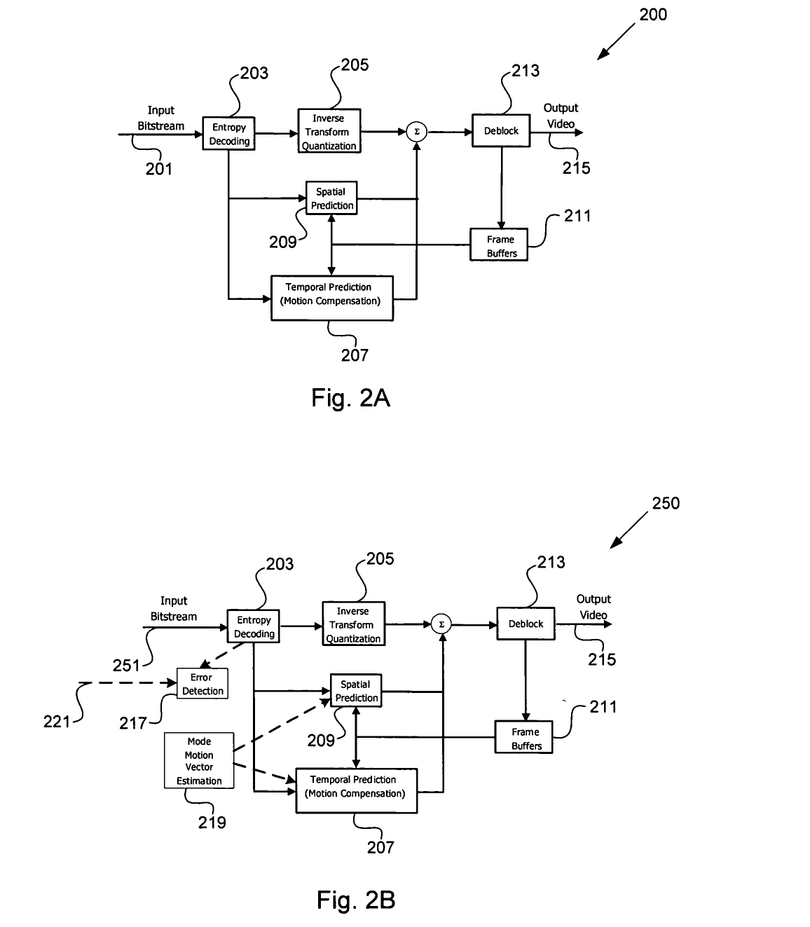

FIG. 2A illustrates a block diagram of a standard digital video decoder 200. The standard digital video decoder 200 may comprise an entropy decoder 203, an inverse transform quantizer 205 such as, for example, the ISQDCT 125 of FIG. 1, a spatial predictor 209 such as, for example, the spatial predictor 120, a temporal predictor (motion compensator) 207 such as, for example, the motion compensator 130, a deblocker 213 such as, for example, the deblocker 140, and a frame buffer 211 such as, for example, the picture buffer 150. A compressed video bit stream 201 may be input to the entropy decoder 203 to extract coded information such as, for example, sequence header, picture header, macro block coding mode, motion vectors, and prediction residual coefficients. The entropy decoder 203 may be capable of determining whether a frame or a field contains erroneous macroblocks, the entropy decoder 203, however, may not be capable of determining the exact macroblock where the error may be.

Each macro block may be decoded sequentially according to the arrival order. Depending on the macro block mode, either spatial predictor 207 or temporal predictor 209 may be used to obtain the prediction macro block. Meanwhile, the residual coefficients may be inverse-quantized and inverse-transformed in the inverse transform quantizer 205. The reconstructed video macro block may then be obtained by adding the residual macro block and the prediction macro block. A deblocker 213 may also be used with to the reconstructed macro block before outputting the video 215, depending on the underlying coding standard and the macro block mode. The output of the de-blocker 213 may be stored in the frame buffer 211, which may be used for prediction coding of future pictures to be decoded.

FIG. 2B illustrates a block diagram of the techniques used in conjunction with the standard digital video decoder of FIG. 2A to conceal errors in video data, in accordance with an embodiment of the present invention. The modified digital decoder 200 may comprise in addition to the elements of the standard digital decoder, an error detector 217 and a mode and motion vector estimator 219. In an embodiment of the present invention, the error detector 217 may identify damaged macro blocks within the frames or fields in which the entropy decoder 213 may have determined presence of erroneous data. The error detector 217 may be informed of presence of error by the entropy decoder 203 and/or may receive information from other components in the system regarding packets with errors via input 221.

In an embodiment of the present invention, the error detector 217 may then send information regarding the damaged macroblocks to the mode and motion vector estimator 219. The mode and motion vector estimator 219 may determine the mode of the macroblock and the motion vector associated with it. The mode of the macroblock may be spatial or temporal. If the mode is spatial, that may indicate that the macroblock may be concealed using another macroblock within the same frame or field. If the mode is temporal, that may indicate that the macroblock may be concealed using a macroblock from another frame or field.

If the mode is spatial, the spatial predictor 209 may be utilized to conceal the part of the image affected by the damaged macroblock. If the mode is temporal, the temporal predictor (motion compensator) 207 may be utilized to conceal the part of the image affected by the damaged macroblock. As a result, the part of the image that may be damaged may be concealed without using any dedicated software/hardware for pixel manipulation for error concealment purposes.

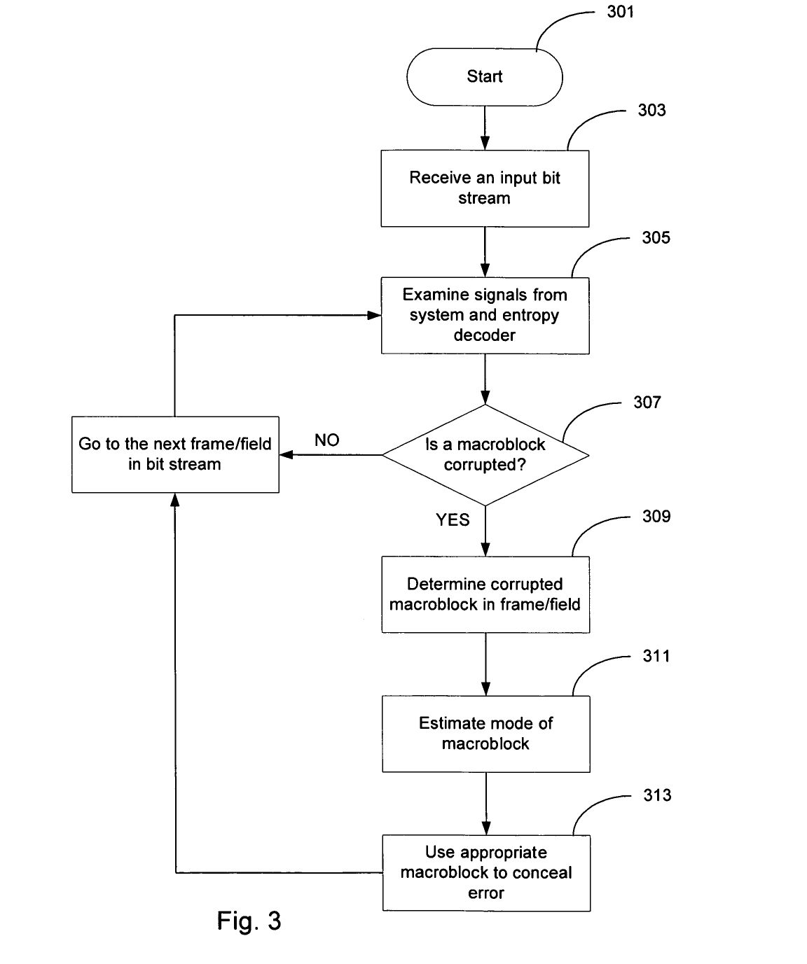

FIG. 3 illustrates a flow diagram of an exemplary method of concealing errors in video data, in accordance with an embodiment of the present invention. The method may start at a starting block 301, at a next block 303 an input bit stream, containing data for a frame or field in a video sequence, may be received. Signals from the system and/or the entropy decoder may then be examined at a block 305, and at a block 307 it may be determined if a macroblock in the current field/frame is corrupt. If the is no corrupt macroblock, then it may be concluded that there is no error in the frame or field, and the next frame or field may be examined starting at block 305. Otherwise, if it is determined that there may be a corrupted macroblock in the field/frame and at a block 309 the macroblock or macroblocks where the actual error is may be determined. The erroneous macroblock may then be examined at a block 311 to estimate the mode of the macroblock, that is, to determine whether the mode of the macroblock may be spatial or temporal. Depending on the mode of the macroblock, spatial or temporal, the appropriate macroblock from another part of the same frame or field or from another frame or field, respectively, may be used in place of the macroblock at a block 313, hence concealing the error caused by the corrupted erroneous macroblock. The next frame or field may then be examined starting at block 305.

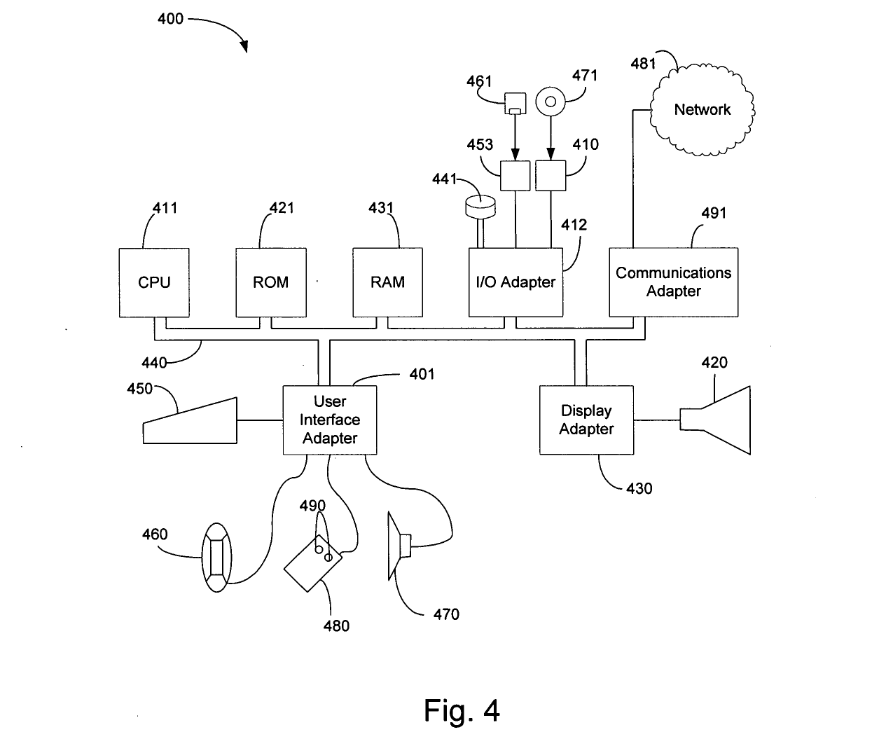

FIG. 4 illustrates an exemplary computer system 400, in accordance with an embodiment of the present invention. A central processing unit (CPU) 411 may be interconnected via a system bus 440 to a random access memory (RAM) 431, a read only memory (ROM) 421, an input/output (I/O) adapter 412, a user interface adapter 401, a communications adapter 491, and a display adapter 430. The I/O adapter 412 may connect to the bus 440 peripheral devices such as hard disc drives 441, floppy disc drives 453 for reading removable floppy discs 461, and optical disc drives 410 for reading removable optical discs 471 (such as a compact disc or a digital versatile disc). The user interface adapter 401 may connect to the bus 440 devices such as a keyboard 450, a mouse 480 having a plurality of buttons 490, a speaker 470, a microphone 460, and/or other user interface devices such as a touch screen device (not shown). The communications adapter 491 may connect the computer system to a data processing network 481. The display adapter 430 may connect a monitor 420 to the bus 440.

An alternative embodiment of the present invention may be implemented as sets of instructions resident in the RAM 431 of one or more computer systems 400 configured generally as described in FIG. 2B and FIG. 3. Until required by the computer system 400, the sets of instructions may be stored in another computer readable memory, for example in a hard disc drive 441, or in removable memory such as an optical disc 471 for eventual use in an optical disc drive 410, or in a floppy disc 461 for eventual use in a floppy disc drive 453. The physical storage of the sets of instructions may physically change the medium upon which it is stored electrically, magnetically, or chemically so that the medium carries computer readable information.

The present invention may be realized in hardware, software, firmware and/or a combination thereof. The present invention may be realized in a centralized fashion in at least one computer system, or in a distributed fashion where different elements are spread across several interconnected computer systems. Any kind of computer system or other apparatus adapted for carrying out the methods described herein may be suitable. A typical combination of hardware and software may be a general-purpose computer system with a computer program that, when being loaded and executed, controls the computer system to carry out the methods described herein.

The present invention may also be embedded in a computer program product comprising all of the features enabling implementation of the methods described herein which when loaded in a computer system is adapted to carry out these methods. Computer program in the present context means any expression, in any language, code or notation, of a set of instructions intended to cause a system having information processing capability to perform a particular function either directly or after either or both of the following: a) conversion to another language, code or notation; and b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method that conceals errors in video data, wherein the video data comprises frames/fields in a video sequence, the method comprising:
determining for each frame/field received whether there is an error in the frame/field;
detecting corrupted macroblocks within the frame/field, if it is determined an error exists in the frame/field;
estimating a mode of prediction and motion vectors associated with each corrupted macroblock; and
utilizing a macroblock associated with the estimated mode of prediction in place of the detected corrupt macroblock.

2. The method according to claim 1 wherein each frame/field comprises a plurality of macroblocks of data.

3. The method according to claim 1 wherein a frame/field has multiple corrupt macroblocks.

4. The method according to claim 1 wherein determining whether there is an error in the frame/field comprises examining information related to the video data.

5. The method according to claim 1 wherein the mode of prediction of a macroblock is spatial.

6. The method according to claim 5 further comprising utilizing a macroblock from the frame/field containing the detected corrupt macroblock to replace the corrupt macroblock.

7. The method according to claim 1 wherein the mode of prediction of a macroblock is temporal.

8. The method according to claim 7 further comprising utilizing a macroblock from a frame/field decoded prior to the frame/field containing the detected corrupt macroblock to replace the corrupt macroblock.

9. A system that conceals errors in video data, wherein the video data comprises frames/fields in a video sequence, the method comprising:
at least one processor capable of determining for each frame/field received whether there is an error in the frame/field;
the at least one processor capable of detecting corrupted macroblocks within the frame/field where the error is, if it is determined an error exists in the frame/field;
the at least one processor capable of estimating a mode of prediction and motion vectors associated with each corrupted macroblock; and
the at least one processor capable of utilizing a macroblock associated with the estimated mode of prediction in place of the detected corrupt macroblock.

10. The system according to claim 9 wherein each frame/field comprises a plurality of macroblocks of data.

11. The system according to claim 9 wherein a frame/field has multiple corrupt macroblocks.

12. The system according to claim 9 wherein to determine whether there is an error in the frame/field the at least one processor is capable of examining information related to the video data.

14. The system according to claim 9 wherein the mode of prediction of a macroblock is spatial.

15. The system according to claim 14 further comprising the at least one processor being capable of utilizing a macroblock from the frame/field containing the detected corrupt macroblock to replace the corrupt macroblock.

16. The system according to claim 9 wherein the mode of prediction of a macroblock is temporal.

17. The system according to claim 16 further comprising the at least one processor being capable of utilizing a macroblock from a frame/field decoded prior to the frame/field containing the detected corrupt macroblock to replace the corrupt macroblock.

18. A machine-readable storage having stored thereon, a computer program having at least one code section that conceals errors in video data, wherein the video data comprises frames/fields in a video sequence, the at least one code section being executable by a machine for causing the machine to perform steps comprising:
determining for each frame/field received whether there is an error in the frame/field;
detecting corrupted macroblocks within the frame/field, if it is determined an error exists in the frame/field;
estimating a mode of prediction and motion vectors associated with each corrupted macroblock; and
utilizing a macroblock associated with the estimated mode of prediction in place of the detected corrupt macroblock.

19. The machine-readable storage according to claim 18 wherein each frame/field comprises a plurality of macroblocks of data.

20. The machine-readable storage according to claim 18 wherein a frame/field has multiple corrupt macroblocks.

21. The machine-readable storage according to claim 18 wherein the code for determining whether there is an error in the frame/field comprises code for examining information related to the video data.

22. The machine-readable storage according to claim 18 wherein the mode of prediction of a macroblock is spatial.

23. The machine-readable storage according to claim 22 further comprising code for utilizing a macroblock from the frame/field containing the detected corrupt macroblock to replace the corrupt macroblock.

24. The machine-readable storage according to claim 18 wherein the mode of prediction of a macroblock is temporal.

25. The machine-readable storage according to claim 24 further comprising code for utilizing a macroblock from a frame/field decoded prior to the frame/field containing the detected corrupt macroblock to replace the corrupt macroblock.
